(19) United States
(12) Patent Application Publication
(10) Pub. No.: US 2020/0284310 A1
(43) Pub. Date: Sep. 10, 2020

(54) SPEED REDUCER, ROTARY DRIVE SYSTEM, AND HYDRAULIC SHOVEL

(71) Applicant: Komatsu Ltd., Tokyo (JP)

(72) Inventors: Akira Minamiura, Tokyo (JP); Masahiko Ishiyama, Tokyo (JP); Naoyuki Iwamoto, Tokyo (JP); Teiichirou Chiba, Tokyo (JP)

(21) Appl. No.: 16/758,120

(22) PCT Filed: Jan. 22, 2019
(86) PCT No.: PCT/JP2019/001931

§ 371 Date: Apr. 22, 2020

(30) Foreign Application Priority Data
Feb. 28, 2018 (JP) 2018-035843

(51) Int. Cl. F16D 55/40; F16D 65/853; F16H 1/46; F16H 57/04; F16N 7/38; E02F 9/12

(52) U.S. Cl. CPC F16D 55/40; F16D 65/853; F16H 1/46; F16H 57/04; F16H 2700/02; E02F 9/128; E02F 9/126; F16H 2716/04; F16N 7/38

(57) ABSTRACT

A speed reducer includes a transmission unit rotating around an axis, an annular member having a cylindrical shape surrounding the axis, rotating around the axis together with the transmission unit, and having an oil sump having a recessed groove recessed in an inner peripheral surface and a lubricating oil supply hole extending and opening radially outward from the recessed groove, and a sliding portion provided radially outward of the lubricating oil supply hole of the annular member.

### TECHNICAL FIELD

The present invention relates to a speed reducer, a rotary drive system, and a hydraulic shovel.

Priority is claimed on Japanese Patent Application No. 2018-035843, filed on Feb. 28, 2018, the content of which is incorporated herein by reference.

### BACKGROUND ART

PTL 1 describes a rotary drive system in which an electric motor and a speed reducer decelerating the rotation of the electric motor are integrally provided. The speed reducer has multi-stage planetary gear mechanisms vertically disposed as a transmission unit. The planetary gear mechanisms are immersed in lubricating oil.

### CITATION LIST

Patent Literature

[PTL 1] Japanese Unexamined Patent Application, First Publication No. 2016-172965

### DISCLOSURE OF INVENTION

### Technical Problem

By the way, for a reduction in stirring loss during rotary drive, at least part of the transmission unit of the speed reducer may be, for example, exposed from the lubricating oil without being immersed in the lubricating oil. Even in such a case, it is required to smoothly supply lubricating oil to a sliding portion of the speed reducer that requires lubrication.

The present invention has been made in view of such problems, and an object of the present invention is to provide a speed reducer, a rotary drive system, and a hydraulic shovel allowing lubricating oil to be smoothly supplied to a sliding portion.

### Solution to Problem

A speed reducer according to an aspect of the present invention includes: an output shaft provided below a rotary shaft that has an axis extending vertically and rotates around the axis, and provided to be rotatable around the axis; a transmission unit interconnecting a lower portion of the rotary shaft and the output shaft, decelerating a rotation of the rotary shaft, and transmitting a decelerated rotation of the rotary shaft to the output shaft; an annular member having a cylindrical shape surrounding the axis and rotating around the axis together with the transmission unit, the annular member including an oil sump having a recessed groove recessed in an inner peripheral surface of the annular member and a lubricating oil supply hole extending radially outward from the recessed groove and being opened; and a sliding portion provided on an outer side of the lubricating oil supply hole of the annular member in a radial direction of the axis.

According to the speed reducer configured as described above, the lubricating oil that has reached the inner peripheral surface of the annular member by being supplied from above is temporarily collected in the oil sump and then flows through the lubricating oil supply hole radially outward and in accordance with a centrifugal force. Then, the lubricating oil discharged from the lubricating oil supply hole is supplied to the sliding portion on the radially outer side of the lubricating oil supply hole. As a result, lubricity can be ensured for the sliding portion.

### Advantageous Effects of Invention

According to the speed reducer, the rotary drive system, and the hydraulic shovel of the above aspect, it is possible to smoothly supply lubricating oil to a sliding portion.

### BRIEF DESCRIPTION OF DRAWINGS

FIG. 1 is a side view of a hydraulic shovel including a rotary drive system according to a first embodiment of the present invention.

FIG. 2 is a plan view of the hydraulic shovel including the rotary drive system according to the first embodiment of the present invention.

FIG. 3 is a schematic diagram showing the outline of the rotary drive system according to the first embodiment of the present invention.

FIG. 4 is a longitudinal cross-sectional view of a rotary drive device in the rotary drive system according to the first embodiment of the present invention.

FIG. 5 is a partially enlarged view of FIG. 4.

FIG. 6 is an enlarged view of a longitudinal cross section of the rotary drive system according to the embodiment of the present invention that is at a position different from FIG. 5.

FIG. 7 is an enlarged view of the vicinity of a brake disk and a brake plate of FIG. 4.

### BEST MODE FOR CARRYING OUT THE INVENTION

### First Embodiment

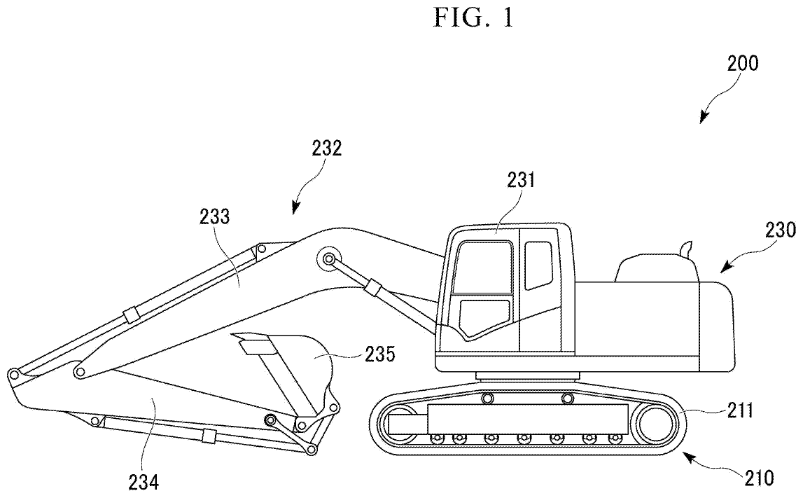

Hereinafter, a first embodiment of the present invention will be described in detail with reference to FIGS. 1 to 7.

### Work Machine

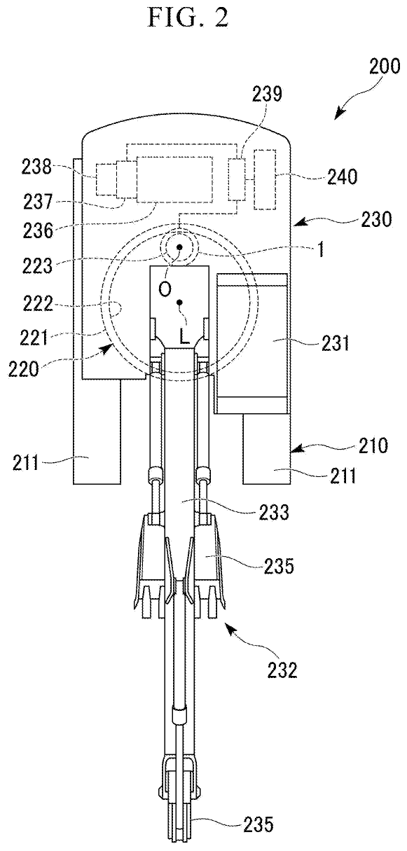

As shown in FIGS. 1 and 2, a hydraulic shovel 200 as a work machine includes an undercarriage 210, a swing circle 220, and an upper swing body 230. In the following description, the direction in which gravity acts in a state where the work machine is installed on a horizontal surface will be referred to as “vertical direction”.

In addition, the front of the driver's seat in a cab 231 (described later) will be simply referred to as “front” and the rear of the driver's seat will be simply referred to as “rear”.

The undercarriage 210 includes a pair of left and right crawlers 211 and 211 and the hydraulic shovel 200 travels by the crawlers 211 and 211 being driven by a traveling hydraulic motor (not shown).

The swing circle 220 is a member interconnecting the undercarriage 210 and the upper swing body 230 and includes an outer race 221, an inner race 222, and a swing pinion 223. The outer race 221 is supported by the undercarriage 210 and has an annular shape about a swing axis L extending so as to match the vertical direction. The inner race 222 is an annular member coaxial with the outer race 221 and is disposed inside the outer race 221. The inner race 222 is supported so as to be rotatable relative to the outer race 221 around the swing axis L. The swing pinion 223 meshes with the internal teeth of the inner race 222 and the inner race 222 rotates relative to the outer race 221 by the swing pinion 223 rotating.

The upper swing body 230 is disposed so as to be capable of swinging around the swing axis L with respect to the undercarriage 210 by being supported by the inner race 222. The upper swing body 230 includes the cab 231, a work equipment 232, an engine 236 provided behind the cab 231 and the work equipment 232, a generator motor 237, a hydraulic pump 238, an inverter 239, a capacitor 240, and a rotary drive system 1.

The cab 231 is disposed on the front left side of the upper swing body 230 and is provided with the driver's seat for a worker. The work equipment 232 is provided so as to extend in front of the upper swing body 230 and includes a boom 233, an arm 234, and a bucket 235. The work equipment 232 performs various works such as excavation by the boom 233, the arm 234, and the bucket 235 being respectively driven by hydraulic cylinders (not shown).

The shafts of the engine 236 and the generator motor 237 are spline-coupled. The generator motor 237 generates electric power by being driven by the engine 236. The rotary shafts of the generator motor 237 and the hydraulic pump 238 are spline-coupled. The hydraulic pump 238 is driven by the engine 236. Each of the hydraulic cylinders and the traveling hydraulic motor described above are driven by the hydraulic pressure that is generated by the hydraulic pump 238 being driven.

The generator motor 237, the capacitor 240, and the rotary drive system 1 are electrically interconnected via the inverter 239. Another electric power storage device such as a lithium-ion battery may be used instead of the capacitor 240. The output of the rotary drive system 1 is transmitted to the swing pinion 223 meshing with the internal teeth of the inner race 222.

The rotary drive system 1 is disposed such that an axis O as a rotation center extends in the vertical direction. Here, “extends in the vertical direction” means that the direction of the axis O extends in a direction including an upward and downward directions, that is, includes a case where the axis O is inclined with respect to the direction that matches the vertical direction.

The hydraulic shovel 200 drives the rotary drive system 1 with the electric power generated by the generator motor 237 or the electric power from the capacitor 240. The drive force of the rotary drive system 1 is transmitted to the inner race 222 via the swing pinion 223. As a result, the upper swing body 230 swings by the inner race 222 rotating relative to the outer race 221.

When the swinging of the upper swing body 230 is decelerated, the rotary drive system 1 generates electric power as regenerative energy by functioning as a generator. This electric power is accumulated in the capacitor 240 via the inverter 239. The electric power accumulated in the capacitor 240 is supplied to the generator motor 237 when the engine 236 is accelerated. The generator motor 237 assists the output of the engine 236 by the generator motor 237 being driven by the electric power of the capacitor.

### Rotary Drive System

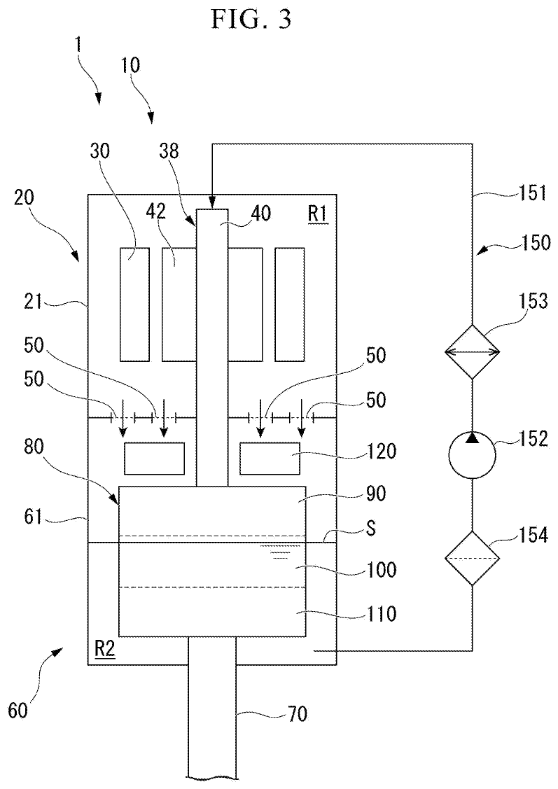

As shown in FIG. 3, the rotary drive system 1 includes a rotary drive device 10 and a lubricating oil circulation unit 150.

### Rotary Drive Device

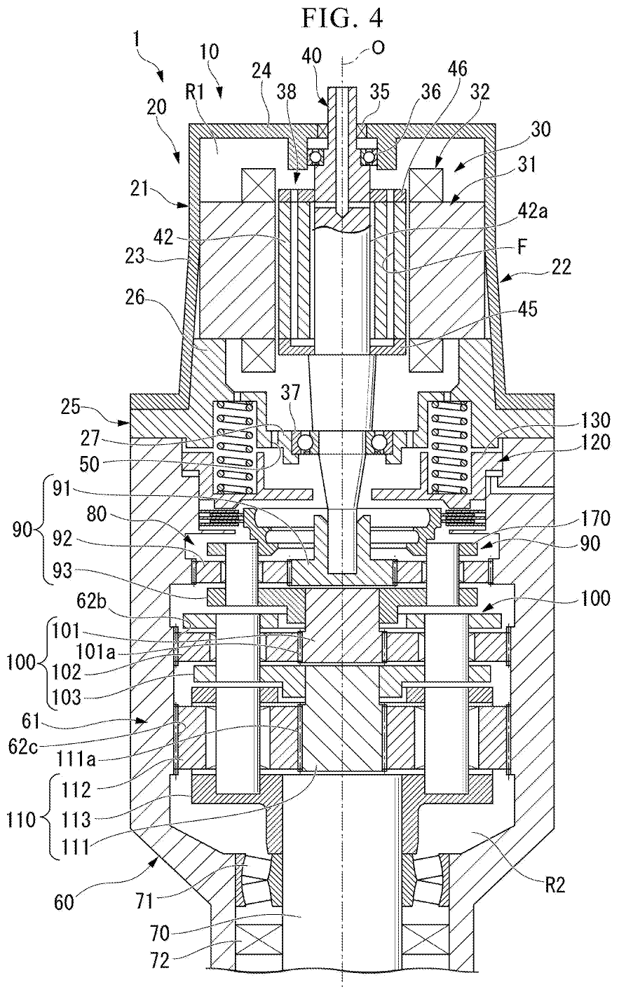

As shown in FIGS. 3 and 4, the rotary drive device 10 includes an electric motor 20 and a speed reducer 60 provided integrally with the electric motor 20. The speed reducer 60 is installed below the electric motor 20.

### Electric Motor

As shown in FIGS. 3 and 4, the electric motor 20 includes an electric motor casing 21, a stator 30, and a rotor 38.

### Electric Motor Casing

As shown in FIG. 4, the electric motor casing 21 is a member forming the outer shape of the electric motor 20. The electric motor casing 21 includes an upper casing 22 and a lower casing 25.

The upper casing 22 has a bottomed cylindrical shape having an upper cylindrical portion 23 having a cylindrical shape and extending in the vertical direction and an upper bottom portion 24 blocking the upper part of the upper cylindrical portion 23.

The lower casing 25 has a bottomed cylindrical shape having a lower cylindrical portion 26 having a cylindrical shape and extending in the vertical direction and a lower bottom portion 27 blocking the lower part of the lower cylindrical portion 26.

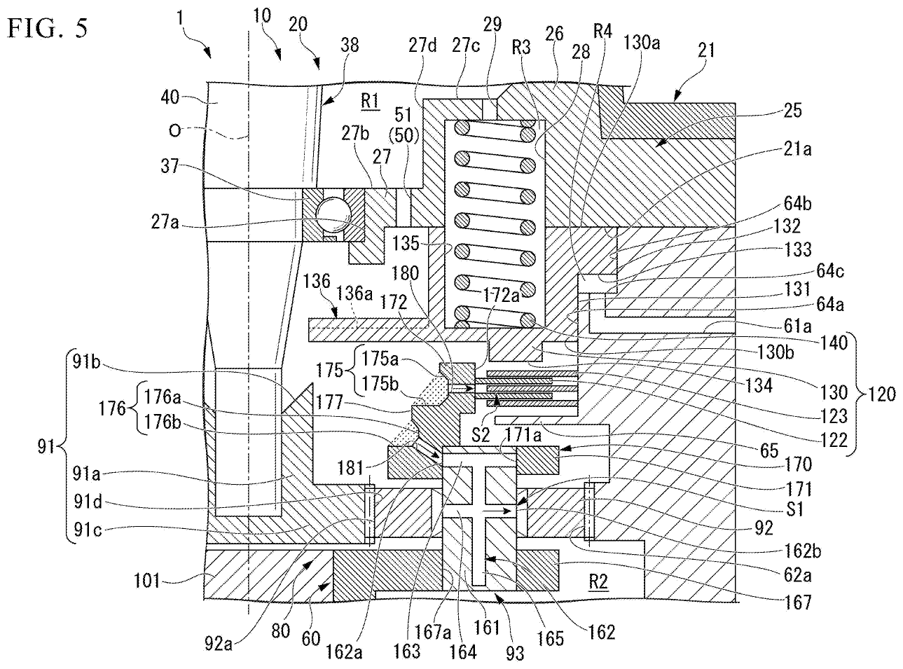

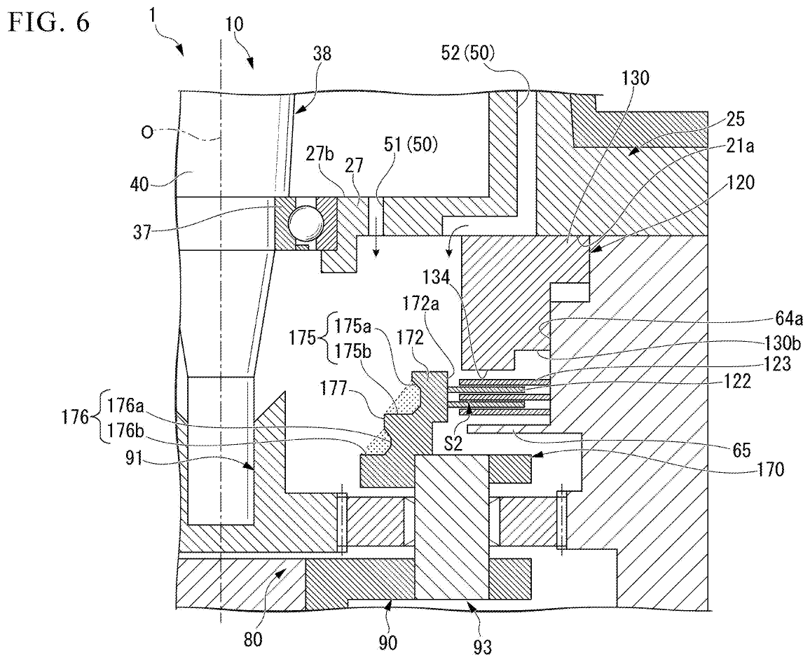

The lower bottom portion 27 serves as the bottom portion of the electric motor casing 21. Specifically, as shown in FIGS. 5 and 6, the lower bottom portion 27 has a lower through hole 27a penetrating the lower bottom portion 27 about the axis O. The part that is around the lower through hole 27a on the surface of the lower bottom portion 27 facing upward is an annular first bottom surface 27b having a flat shape orthogonal to the axis O. On the outer peripheral side of the first bottom surface 27b of the lower bottom portion 27, a plurality of second bottom surfaces 27c (see FIG. 5) formed one step higher than the first bottom surface 27b arc formed at intervals in the circumferential direction. Part of the first bottom surface 27b is disposed between the second bottom surfaces 27c that are adjacent to each other in the circumferential direction. The first bottom surface 27b and the second bottom surface 27c are interconnected by a stepped portion 27d extending in the vertical direction. The outer peripheral side end portion of the second bottom surface 27c is connected to the inner peripheral surface of the lower cylindrical portion 26.

As shown in FIG. 4, the outer peripheral surface of the lower cylindrical portion 26 is fitted to the inner peripheral surface of the upper cylindrical portion 23 in such a manner that the lower cylindrical portion 26 is inserted into the upper cylindrical portion 23 from below. As a result, the lower cylindrical portion 26 and the upper cylindrical portion 23 are integrally fixed to each other. The space inside the electric motor casing 21 that is formed by the lower cylindrical portion 26 and the upper cylindrical portion 23 is an upper accommodation space R1.

### Communication Hole

Here, as shown in FIGS. 5 and 6, the electric motor casing 21 has a communication hole 50 allowing the upper accommodation space R1 in the electric motor casing 21 to communicate downward. In the present embodiment, the communication hole 50 includes an inner peripheral-side communication hole 51 and an outer peripheral-side communication hole 52.

The inner peripheral-side communication hole 51 is formed so as to open in the first bottom surface 27b in the lower bottom portion 27 of the lower casing 25 and vertically penetrates the lower bottom portion 27. A plurality of the communication holes 50 arc formed at intervals in the circumferential direction.

As shown in FIG. 6, the outer peripheral-side communication hole 52 is formed so as to vertically penetrate the lower cylindrical portion 26 of the lower casing 25. The opening of the lower surface of the lower casing 25 of the outer peripheral-side communication hole 52, that is, the opening of a lower surface 21a of the electric motor casing 21 is formed so as to expand radially inward.

### Stator

As shown in FIG. 4, the stator 30 includes a stator core 31 and a coil 32.

The stator core 31 is configured by a plurality of electromagnetic steel plates being stacked in the vertical direction and has a cylindrical shape about the axis O. The stator core 31 includes a yoke and a plurality of teeth formed at intervals in the circumferential direction of the yoke so as to protrude from the inner peripheral surface of the yoke. The stator core is fixed to the electric motor casing 21.

A plurality of the coils 32 are provided so as to correspond to the respective teeth and wound around the respective teeth. As a result, the plurality of coils 32 are provided at intervals in the circumferential direction.

### Rotor

As shown in FIG. 4, the rotor 38 includes a rotary shaft 40, a rotor core 42, a lower end plate 45, and an upper end plate 46.

### Rotary Shaft

The rotary shaft 40 is a rod-shaped member extending along the axis O. The rotary shaft 40 is disposed in the electric motor casing 21 so as to penetrate the inside of the stator 30 in the vertical direction. The upper end of the rotary shaft 40 protrudes above the upper bottom portion 24 in the upper casing 22. In addition, the upper end of the rotary shaft 40 may be accommodated in the electric motor casing 21.

The upper bottom portion 24 is provided with an upper seal 35 for sealing between the upper bottom portion 24 and the outer peripheral surface of the rotary shaft 40. As a result, liquid tightness is ensured at the upper end inside the electric motor casing 21.

### Rotor Core

The rotor core 42 has a cylindrical shape about the axis O and an inner peripheral surface 42a is externally fitted on the outer peripheral surface of the rotary shaft 40. The rotor core 42 is configured by a plurality of electromagnetic steel plates being stacked in the vertical direction. In the rotor core 42, a plurality of permanent magnets (not shown) are embedded at intervals in the circumferential direction.

### Lower End Plate

The lower end plate 45 is fixed so as to be stacked on the rotor core 42 from below the rotor core 42.

### Upper End Plate

The upper end plate 46 is fixed so as to be stacked on the rotor core 42 from above the rotor core 42.

### Intra-rotor Flow Path F

The rotor 38 has an intra-rotor flow path F extending downward from the upper end of the rotary shaft 40 and passing between the rotary shaft 40 and the rotor core 42, through the lower end plate 45, through the rotor core 42, and through the upper end plate 46. The intra-rotor flow path F is open from the upper surface of the upper end plate 46 into the upper accommodation space RI.

### Upper Bearing

The upper bottom portion 24 is provided with an upper bearing 36 having an annular shape about the axis O. The rotary shaft 40 is vertically inserted through the upper bearing 36 and the upper portion of the rotary shaft 40 is supported by the upper bearing 36 so as to be rotatable around the axis O.

### Lower Bearing

As shown in FIGS. 5 and 6, the lower through hole 27a in the lower bottom portion 27 is provided with a lower bearing 37 having an annular shape about the axis O. The rotary shaft 40 is vertically inserted through the lower bearing 37 and the lower portion of the rotary shaft 40 is supported by the lower bearing 37 so as to be rotatable around the axis O. The upper surface of the lower bearing 37 has the same height as the first bottom surface 27b. Lubricating oil introduced into the lower bearing 37 passes through the lower bearing 37 and falls downward.

### Speed Reducer

Next, the speed reducer 60 will be described with reference to FIG. 4. The speed reducer 60 includes a speed reducer casing 61, an output shaft 70, a transmission unit 80, an annular member 170, and a brake mechanism 120.

### Speed Reducer Casing

The speed reducer casing 61 has a cylindrical shape extending along the axis O and open upward and downward. The upper end of the speed reducer casing 61 abuts the electric motor casing 21 from below. The upper opening of the speed reducer casing 61 is blocked by the lower casing 25 of the electric motor casing 21.

### Output Shaft

The output shaft 70 has a rod shape extending along the axis O. The rotation of the output shaft 70 becomes the output of the rotary drive system 1. The upper portion of the output shaft 70 is disposed in the speed reducer casing 61 and the lower portion of the output shaft 70 protrudes downward from the speed reducer casing 61. An output shaft bearing 71 supporting the output shaft 70 so as to be rotatable around the axis O is provided below the inner peripheral surface of the speed reducer casing 61. The lower portion of the output shaft 70 that protrudes downward from the speed reducer casing 61 is connected to the swing pinion 223.

A lower seal 72 sealing the annular space between the inner peripheral surface of the speed reducer casing 61 and the outer peripheral surface of the output shaft 70 is provided further below the output shaft bearing 71 on the inner peripheral surface of the speed reducer casing 61. The space in the speed reducer casing 61 that is blocked from below by the lower seal 72 is a lower accommodation space R2. The lower portion of the rotary shaft 40 that protrudes downward from the electric motor casing 21 is positioned above the lower accommodation space R2. Lubricating oil is stored up to a predetermined height position in the lower accommodation space R2. In other words, the lower accommodation space R2 functions as a lubricating oil storage tank.

### Transmission Unit

The transmission unit 80 is provided in the lower accommodation space R2 in the speed reducer casing 61. The transmission unit 80 has a role of reducing the rotational speed of the rotary shaft 40 and transmitting the reduced rotational speed to the output shaft 70.

The transmission unit 80 includes multi-stage planetary gear mechanisms sequentially reducing the rotational speed from the rotary shaft 40 to the output shaft 70. In the present embodiment, the three planetary gear mechanisms of a first stage planetary gear mechanism 90, a second stage planetary gear mechanism 100, and a third stage planetary gear mechanism 110 are provided as the plurality of planetary gear mechanisms.

### First Stage Planetary Gear Mechanism

The first stage planetary gear mechanism 90 is a planetary gear mechanism disposed at a first stage. The first stage planetary gear mechanism 90 includes a first stage transmission shaft (transmission shaft) 91, a first stage planetary gear (planetary gear) 92, and a first stage carrier (carrier) 93.

The first stage transmission shaft 91 is externally fitted from the lower end to the lower portion of the rotary shaft 40. The first stage transmission shaft 91 is rotatable around the axis O integrally with the rotary shaft 40.

More specifically, as shown in FIGS. 5 and 6, the first stage transmission shaft 91 includes a cylindrical portion 91a and a flange portion 91c. The cylindrical portion 91a has a bottomed cylindrical shape extending about the axis and blocked at the lower end. The inner peripheral surface of the cylindrical portion 91a is spline-coupled to the outer peripheral surface of the lower portion of the rotary shaft 40. In addition, the inner peripheral surface of the cylindrical portion 91a and the outer peripheral surface of the lower portion of the rotary shaft 40 may form another connection structure. An upper end 91b of the cylindrical portion 91a has a reverse taper shape inclined downward from the radially outer side to the inner side. In other words, the upper end 91b of the cylindrical portion 91a decreases in diameter downward.

The flange portion 91c is formed so as to overhang radially outward from the lower end of the cylindrical portion 91a. Sun gear teeth 91d as outer gear teeth are formed on the outer peripheral surface of the flange portion 91c.

The first stage planetary gear 92 has planetary gear teeth 92a on the outer peripheral surface. A plurality of the first stage planetary gears 92 are provided at intervals in the circumferential direction around the first stage transmission shaft 91 such that the planetary gear teeth 92a mesh with the sun gear teeth 91d of the first stage transmission shaft 91. The planetary gear teeth 92a of the first stage planetary gear 92 mesh with first stage inner gear teeth 62a formed on the inner peripheral surface of the speed reducer casing 61.

The first stage carrier 93 supports the first stage planetary gear 92 so as to be capable of rotating and revolving around the axis O. The first stage carrier 93 includes a carrier shaft 161 and a carrier main body 167.

The carrier shaft 161 is a vertically extending rod-shaped member and a plurality of the carrier shafts 161 arc provided so as to correspond to the respective first stage planetary gears 92. The carrier shaft 161 penetrates the center of each first stage planetary gear 92 in the vertical direction and rotatably supports the first stage planetary gear 92. The intermediate portion of the carrier shaft 161 in the vertical direction slides with the inner peripheral surface of the first stage planetary gear 92. In other words, the outer peripheral surface of the intermediate portion of the carrier shaft 161 and the inner peripheral surface of the first stage planetary gear 92 are a sliding surface (sliding portion) S1.

An intra-shaft flow path 162 is formed in the carrier shaft 161. The intra-shaft flow path 162 includes an upper radial flow path 163, an intermediate radial flow path 164, and an axial flow path 165.

The upper radial flow path 163 is a flow path extending along the radial direction of the axis O of the rotary shaft 40 in the upper portion of the carrier shaft 161. The upper radial flow path 163 passes through the carrier shaft 161 in the radial direction of the axis O. The opening in the upper radial flow path 163 that is on the inner side of the radial direction of the axis O of the rotary shaft 40 is a first opening portion 162a of the intra-shaft flow path 162.

The intermediate radial flow path 164 is a flow path extending along the radial direction of the axis O of the rotary shaft 40 in the middle portion of the carrier shaft 161. The upper radial flow path 163 passes through the carrier shaft 161 in the radial direction of the axis O. Both ends of the intermediate radial flow path 164 are open in the sliding surface S1 with respect to the first stage planetary gear 92. The opening in the intermediate radial flow path 164 that is on the radially outer side with respect to the axis O with respect to the axis O of the rotary shaft 40 is a second opening portion 162b of the intra-shaft flow path 162.

The axial flow path 165 is a flow path extending in the vertical direction at the center of the carrier shaft 161. The upper end of the axial flow path 165 communicates with the upper radial flow path 163. The lower end of the axial flow path 165 is blocked without opening on the lower surface of the carrier shaft 161. The intermediate portion of the axial flow path 165 in the vertical direction communicates with the intermediate radial flow path 164.

The carrier main body 167 has a disk shape about the axis O. The carrier main body 167 is disposed below each first stage planetary gear 92 so as to face the first stage planetary gear 92. The carrier main body 167 has a lower fitting hole 167a into which the outer peripheral surface of the lower portion of the carrier shaft 161 is fitted.

### Second Stage Planetary Gear Mechanism

As shown in FIGS. 4 and 5, the second stage planetary gear mechanism 100 includes a second stage transmission shaft 101, a second stage planetary gear 102, and a second stage carrier 103. The second stage transmission shaft 101 is provided below the first stage transmission shaft 91 so as to be rotatable around the axis O and is connected to the carrier main body 167 in the first stage carrier 93. The second stage planetary gear 102 meshes with sun gear teeth 101a formed on the second stage transmission shaft 101 and second stage inner gear teeth 62b formed on the inner peripheral surface of the speed reducer casing 61. The second stage planetary gear 102 is supported by the second stage carrier 103 so as to be capable of rotating and revolving around the axis O.

### Third Stage Planetary Gear Mechanism

The third stage planetary gear mechanism 110 includes a third stage transmission shaft 111, a third stage planetary gear 112, and a third stage carrier 113. The third stage transmission shaft 111 is provided below the second stage transmission shaft 101 so as to be rotatable around the axis O and is connected to the second stage carrier 103. The third stage planetary gear 112 meshes with sun gear teeth 111a formed on the third stage transmission shaft 111 and third stage inner gear teeth 62c formed on the inner peripheral surface of the speed reducer casing 61. The third stage planetary gear 112 is supported by the third stage carrier 113 so as to be capable of rotating and revolving around the axis O. The third stage carrier 113 is connected to the output shaft 70.

The transmission unit 80 transmits the rotation of the rotary shaft 40 to the output shaft 70 after decelerating the rotation of the rotary shaft 40 a plurality of times by means of the multi-stage planetary gear mechanisms.

### Annular Member

As shown in FIG. 5, the annular member 170 has an annular shape about the axis O and is provided integrally with the first stage carrier 93 in the present embodiment. The annular member 170 includes an annular plate portion 171 and an annular cylindrical portion 172.

The annular plate portion 171 has a disk shape about the axis O. The annular plate portion 171 is disposed above each first stage planetary gear 92 so as to face the first stage planetary gear 92. The annular plate portion 171 has an upper fitting hole (fitting hole) 171a into which the outer peripheral surface of the upper portion of the carrier shaft 161 is fitted. By the carrier shaft 161 being fitted into the upper fitting hole 171a, the annular member 170 can be rotated around the axis O integrally with the first stage carrier 93.

The annular cylindrical portion 172 is a cylindrical member about the axis O and has a lower end integrally fixed to the annular plate portion 171. The annular cylindrical portion 172 has a shape in which the inner peripheral surface and the outer peripheral surface increase in diameter in stages upward.

The uppermost part of the outer peripheral surface of the annular cylindrical portion 172 is a disk support surface 172a forming a cylindrical surface about the axis O.

### Oil Sump

An upper oil sump 175 and a lower oil sump 176 as oil sumps temporarily storing lubricating oil are formed in the inner peripheral surface of the annular cylindrical portion 172. The upper oil sump 175 and the lower oil sump 176 are disposed at an interval in the vertical direction. The upper oil sump 175 is positioned above the lower oil sump 176.

The upper oil sump 175 and the lower oil sump 176 have recessed grooves 175a and 176a and receiving surfaces 175b and 176b.

The recessed grooves 175a and 176a are annular grooves recessed radially outward from the inner peripheral surface of the annular cylindrical portion 172 and extending over the entire circumferential direction. The receiving surfaces 175b and 176b are annular surfaces extending radially inward from the lower ends of the recessed grooves 175a and 176a and extending in the circumferential direction. The receiving surfaces 175b and 176b have a flat shape orthogonal to the axis O and have an annular shape extending over the entire circumferential direction. The receiving surfaces 175b and 176b protrude radially inward beyond the upper ends of the recessed grooves 175a and 176a to which the receiving surfaces 175b and 176b are connected.

The upper oil sump 175 is positioned radially outward of the lower oil sump 176. The radially inner end portion of the receiving surface 175b of the upper oil sump 175 is connected to the upper end of the recessed groove 176a of the lower oil sump 176 via a connecting inner peripheral surface 177 forming an inner peripheral cylindrical surface about the axis O. In other words, the upper oil sump 175 and the lower oil sump 176 have a stepped shape in which the lower oil sump 176 positioned below is disposed on the radially inner side.

Here, the volume of the recessed groove 175a of the upper oil sump 175 is larger than the volume of the recessed groove 176a of the lower oil sump 176. Further, the radial dimension of the receiving surface 175b of the upper oil sump 175 is larger than the radial dimension of the receiving surface 176b of the lower oil sump 176. In a cross-sectional shape including the axis O, the area in the upper oil sump 175 surrounded by a line segment interconnecting the upper end of the recessed groove 175a of the upper oil sump 175 and the radially inner end portion of the receiving surface 175b is larger than the area in the lower oil sump 176 surrounded by a line segment interconnecting the upper end of the recessed groove 176a of the lower oil sump 176 and the radially inner end portion of the receiving surface 176b. As a result, in a case where the annular cylindrical portion 172 rotates around the axis O, the volume by which the upper oil sump 175 is capable of accommodating lubricating oil is larger than the volume by which the lower oil sump 176 is capable of accommodating lubricating oil.

### Lubricating Oil Supply Hole

The annular member 170 has an upper lubricating oil supply hole 180 as a lubricating oil supply hole allowing the bottom portion of the recessed groove 175a of the upper oil sump 175 and the disk support surface 172a to communicate with each other in the radial direction. The upper lubricating oil supply hole 180 extends along a direction orthogonal to the axis O. A plurality of the upper lubricating oil supply holes 180 are formed at intervals in the circumferential direction.

The annular member 170 has a lower lubricating oil supply hole 181 as a lubricating oil supply hole allowing the bottom portion of the recessed groove 176a of the lower oil sump 176 and the inner peripheral surface of the upper fitting hole 171a to communicate with each other. The lower lubricating oil supply hole 181 extends radially outward and downward from the bottom portion of the recessed groove 176a and is open in the inner peripheral surface of the upper fitting hole 171a. The radially outer end portion of the lower lubricating oil supply hole 181 is connected to the first opening portion 162a of the carrier shaft 161. As a result, the lower lubricating oil supply hole 181 communicates with the intra-shaft flow path 162. A plurality of the lower lubricating oil supply holes 181 are formed in accordance with the number of the carrier shafts 161.

In addition, the configuration of the lubricating oil supply hole is not limited to the above and another configuration may be adopted insofar as the lubricating oil supply hole extends in the radial direction. In addition, insofar as the upper oil sump 175 and the lower oil sump 176 arc respectively provided at positions corresponding to the upper lubricating oil supply hole 180 and the lower lubricating oil supply hole 181, the upper oil sump 175 and the lower oil sump 176 may not have the annular shape extending over the entire circumferential direction.

### Brake Mechanism

Next, the brake mechanism 120 will be described with reference to FIGS. 5 and 6.

The brake mechanism 120 is disposed above the first stage planetary gear mechanism 90 in the lower accommodation space R2 of the speed reducer casing 61.

The brake mechanism 120 includes a brake disk 122, a brake plate 123, a brake piston 130, and a brake spring 140. The brake mechanism 120 further includes a gutter portion 136.

### Brake Disk

As shown in FIGS. 5 to 7, the brake disk 122 is an annular member and is used as a “wet disk”. A plurality of the brake disks 122 (two brake disks 122 in the present embodiment) are disposed at intervals in the vertical direction so as to overhang from the disk support surface 172a of the annular member 170. The brake disk 122 has a plate shape and the vertical direction is the plate thickness direction of the plate shape.

The inner peripheral edge portion of the brake disk 122 may have an uneven shape in which a recessed portion and a projecting portion are continuous in the circumferential direction. The disk support surface 172a may have an uneven shape corresponding to the inner peripheral edge portion of the brake disk 122. And the brake disk 122 may be fixed to the disk support surface 172a by the uneven shapes of the inner peripheral edge portion of the brake disk 122 and the disk support surface 172a fitting together.

The opening position of the upper lubricating oil supply hole 180 in the disk support surface 172a is the height position between the pair of brake disks 122.

### Brake Plate

The brake plate 123 is an annular member and a plurality of the brake plates 123 (three brake plates 123 in the present embodiment) are disposed at intervals in the vertical direction so as to overhang from the inner peripheral surface of the speed reducer casing 61. The brake plate 123 has a plate shape and the vertical direction is the plate thickness direction of the plate shape. The brake plate 123 is provided so as to overhang from a first sliding contact inner peripheral surface 64a on the inner peripheral surface of the speed reducer casing 61. The first sliding contact inner peripheral surface 64a has an inner peripheral cylindrical surface shape about the axis O.

On the outer peripheral edge portion of the brake plate 123, a plurality of projecting portions protruding radially outward may be formed at intervals in the circumferential direction. In the first sliding contact inner peripheral surface 64a, recessed portions corresponding to the projecting portions of the brake plate 123 may be formed at intervals in the circumferential direction. The brake plate 123 may be provided so as to be immovable in the circumferential direction and movable in the vertical direction by the projecting portion fitting into the recessed portion of the first sliding contact inner peripheral surface 64a.

The plurality of brake plates 123 and the plurality of brake disks 122 are alternately disposed in the order of the brake plates 123 and the brake disks 122 downward from above. The brake plate 123 and the brake disk 122 are capable of abutting each other in the vertical direction. The abutting surface between the brake plate 123 and the brake disk 122 is a sliding contact surface (sliding portion) S2. The outer peripheral edge portion of the brake disk 122 faces the first sliding contact inner peripheral surface 64a at intervals from the radially inner side. The inner peripheral edge portion of the brake plate 123 faces the outer peripheral surface of the disk support surface 172a of the annular member 170 at an interval from the radially outer side.

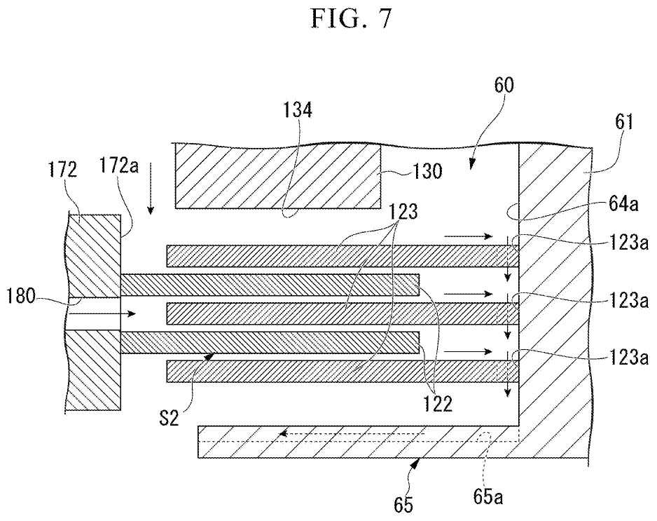

Here, as shown in FIG. 7, a through hole 123a penetrating the brake plate 123 in the vertical direction is formed in the outer peripheral edge portion of each brake plate 123. A plurality of the through holes 123a are formed at intervals in the circumferential direction. The through holes 123a of the plurality of brake plates 123 are at the same circumferential position. In addition, the through hole 123a may be, for example, a gap formed between the top portion of the projecting portion of the brake plate 123 and the bottom portion of the recessed portion of the first sliding contact inner peripheral surface.

Further, an overhanging portion 65 overhanging radially inward is formed on the inner peripheral surface of the speed reducer casing 61. The overhanging portion 65 has an annular shape about the axis O and a plate shape and the vertical direction is the plate thickness direction of the plate shape. The upper surface of the overhanging portion 65 faces the lowermost brake plate 123 from below. Formed in the upper surface of the overhanging portion 65 is a guiding recessed portion 65a recessed downward and extending in the radial direction at the same circumferential position as the through hole 123a. A plurality of the guiding recessed portions 65a are formed at intervals in the circumferential direction. The guiding recessed portion 65a extends from a first sliding contact outer peripheral surface to the inner peripheral end portion of the overhanging portion 65 and is open radially inward in the inner peripheral end portion.

### Brake Piston

As shown in FIGS. 5 to 7, the brake piston 130 is an annular member about the axis O and is disposed between the upper surface of the brake plate 123 and the lower surface 21a of the electric motor casing 21 in the lower accommodation space R2. The brake piston 130 is capable of reciprocating in the vertical direction.

An upper surface 130a of the brake piston 130 faces the lower surface 21a of the electric motor casing 21 from below. The lower portion of the outer peripheral surface of the brake piston 130 is a first sliding contact outer peripheral surface 131 having a circular cross-sectional shape orthogonal to the axis O. The first sliding contact outer peripheral surface 131 of the brake piston 130 is slidable in the vertical direction with respect to the first sliding contact inner peripheral surface 64a of the speed reducer casing 61.

The upper portion of the outer peripheral surface of the brake piston 130 is a second sliding contact outer peripheral surface 132 having a circular cross-sectional shape orthogonal to the axis O. The second sliding contact outer peripheral surface 132 is larger in outer diameter than the first sliding contact outer peripheral surface 131. The second sliding contact outer peripheral surface 132 of the brake piston 130 is slidable in the vertical direction with respect to a second sliding contact inner peripheral surface 64b of the speed reducer casing 61. The second sliding contact inner peripheral surface 64b of the speed reducer casing 61 is larger in inner diameter than the first sliding contact inner peripheral surface 64a.

The step portion in the brake piston 130 that is between the first sliding contact outer peripheral surface 131 and the second sliding contact outer peripheral surface 132 is a pressure receiving surface 133 forming a flat shape orthogonal to the axis O, facing downward, and forming an annular shape.

The step portion in the speed reducer casing 61 that is between the first sliding contact inner peripheral surface 64a and the second sliding contact inner peripheral surface 64b is a stepped surface 64c forming a flat shape orthogonal to the axis O, facing upward, and forming an annular shape.

The pressure receiving surface 133 and the stepped surface 64c face each other in the vertical direction and approach and separate from each other as the brake piston 130 moves in the vertical direction. The annular space between the pressure receiving surface 133 and the stepped surface 64c is a hydraulic pressure supply space R4.

The speed reducer casing 61 has a hydraulic pressure supply hole 61a interconnecting the stepped surface 64c and the outside of the speed reducer casing 61. The hydraulic pressure supply space R4 communicates with the outside via the hydraulic pressure supply hole 61a. The hydraulic pressure that is generated by the hydraulic pump 238 is introduced into the hydraulic pressure supply hole 61a in a case where, for example, the swinging lock lever of the hydraulic shovel 200 is released.

On an annular lower surface 130b of the brake piston 130, a plate abutting surface 134 having an annular shape about axis O is formed so as to protrude from the lower surface 130b. The plate abutting surface 134 faces the brake plate 123 from above over the entire circumferential direction.

The upper surface 130a of the brake piston 130 has a piston-side accommodation recessed portion 135 recessed downward from above. A plurality of the piston-side accommodation recessed portions 135 are disposed at intervals in the circumferential direction.

The lower surface 21a of the electric motor casing 21 has a casing-side accommodation recessed portion 28 recessed upward from below. A plurality of the casing-side accommodation recessed portions 28 are disposed at intervals in the circumferential direction. The casing-side accommodation recessed portion 28 is disposed at the circumferential position that corresponds to the second bottom surface 27c. Each casing-side accommodation recessed portion 28 and each piston-side accommodation recessed portion 135 are provided at the same circumferential position so as to correspond to each other in a one-to-one relationship. The electric motor casing 21 has a hole portion 29 allowing the casing-side accommodation recessed portion 28 and the second bottom surface 27c to communicate with each other.

A space defined by the casing-side accommodation recessed portion 28 and the piston-side accommodation recessed portion 135 is defined as a spring accommodation space R3.

In addition, the outer peripheral-side communication hole 52 is open in the lower surface 21a of the electric motor casing 21 radially inward of the brake piston 130.

### Brake Spring

The brake spring 140 is provided in the spring accommodation space R3 and presses the brake piston 130 in a direction away from the electric motor casing 21.

The brake spring 140 of the present embodiment is a coil spring and is disposed in a posture allowing expansion and contraction in the vertical direction in the spring accommodation space R3. The brake spring 140 is accommodated in a compressed state in the spring accommodation space R3. The upper end of the brake spring 140 abuts against the bottom surface of the casing-side accommodation recessed portion 28 in the electric motor casing 21 and the lower end of the brake spring 140 abuts the bottom surface of the piston-side accommodation recessed portion 135 in the brake piston 130.

### Gutter Portion

At the lower end of the brake piston 130, the gutter portion 136 extending radially inward from the inner peripheral surface of the brake piston 130 is provided integrally with the brake piston 130. A plurality of the gutter portions 136 are provided at intervals in the circumferential direction. For example, in the present embodiment, two gutter portions 136 are provided at an interval of 180° in the circumferential direction. A flow path groove 136a extending in the direction of extension of the gutter portion 136 is formed in the upper surface of the gutter portion 136. The flow path groove 136a is open radially inward in the radially inner end portion of the gutter portion 136. The radially inner end portion of the gutter portion 136 is positioned above the upper end surface of the first stage transmission shaft 91. In other words, the radially inner end portion of the gutter portion 136 is positioned above the fitting portion between the rotary shaft 40 and the first stage transmission shaft 91.

### Lubricating Oil Circulation Unit

As shown in FIG. 3, the lubricating oil circulation unit 150 supplies lubricating oil into the upper accommodation space R1 in the electric motor casing 21 and re-supplies the lubricating oil collected from the inside of the lower accommodation space R2 in the speed reducer casing 61 into the upper accommodation space R1.

The lubricating oil circulation unit 150 includes a lubricating oil flow path 151, a lubricating oil pump 152, a cooling unit 153, and a strainer 154.

The lubricating oil flow path 151 is a flow path formed by a flow path forming member such as piping provided outside the rotary drive device 10. A first end of the lubricating oil flow path 151, which is an upstream side end portion thereof, is connected to the lower accommodation space R2 in the speed reducer casing 61. In the present embodiment, the first end of the lubricating oil flow path 151 is connected to the part in the lower accommodation space R2 that is between the output shaft bearing 71 and the lower seal 72.

A second end of the lubricating oil flow path 151, which is a downstream side end portion thereof, is connected to the opening of the intra-rotor flow path F at the upper end of the rotary shaft 40. The second end of the lubricating oil flow path 151 is connected to the upper accommodation space R1 in the electric motor casing 21 via the intra-rotor flow path F.

The lubricating oil pump 152 is provided in the flow path of the lubricating oil flow path 151 and pumps lubricating oil from the first end toward the second end of the lubricating oil flow path 151, that is, from the lower accommodation space R2 side toward the upper accommodation space R1 side.

The cooling unit 153 is provided at the part of the lubricating oil flow path 151 that is downstream of the lubricating oil pump 152. The cooling unit 153 cools the lubricating oil that flows through the lubricating oil flow path 151 by heat exchange with the external atmosphere.

The strainer 154 is provided at the part of the lubricating oil flow path 151 that is upstream of the lubricating oil pump 152. The strainer 154 has a filter removing dust and dirt from the lubricating oil that passes through the lubricating oil flow path 151. It is preferable that the strainer 154 includes a magnetic filter removing, for example, iron powder generated from the gear teeth of the speed reducer 60.

In the present embodiment, lubricating oil is stored in the second accommodation space R2 in the speed reducer casing 61. And, of the planetary gear mechanisms, the second stage planetary gear mechanism 100 and the third stage planetary gear mechanism 110 are immersed in the lubricating oil. In other words, a liquid surface S of the lubricating oil in the lower accommodation space R2 is positioned between the first stage planetary gear mechanism 90 and the second stage planetary gear mechanism 100.

### Action and Effect

When the engine 236 of the hydraulic shovel 200 is started, hydraulic pressure is generated by the hydraulic pump 238 being simultaneously driven. Then, by the swinging lock lever being released, the brake of the rotary shaft 40 of the rotary drive system is released and the rotary shaft becomes rotatable.

In other words, the brake piston 130 of the brake mechanism 120 is pressed downward by the brake spring 140. As a result, in a state where no hydraulic pressure is supplied to the hydraulic pressure supply space R4, the brake piston 130 moves downward and presses the brake disk 122 via the brake plate 123. At this time, the rotary shaft 40 is in a non-rotatable brake state by the frictional force between the brake plate 123 and the brake disk 122.

Then, the brake piston 130 that has received the hydraulic pressure on the pressure receiving surface 133 moves upward when the hydraulic pressure is supplied to the hydraulic pressure supply space R4 via the hydraulic pressure supply hole 61a by the swinging lock lever being unlocked. As a result, the pressing of the brake plate 123 and the brake disk 122 by the brake piston 130 is released and the rotary shaft 40 is put into a rotatable brake release state.

Then, the rotary drive system 1 is driven and the upper swing body 230 swings by the swinging lever in the cab 231 being operated.

In other words, when the swinging lever is operated, alternating current electric power is supplied to each coil 32 of the stator 30 of the electric motor 20 via the inverter 239 and the rotor 38 rotates with respect to the stator 30 by each permanent magnet following the rotating magnetic field that is generated by the coils 32. The rotation of the rotary shaft 40 of the rotor 38 is decelerated via the transmission unit 80 in the speed reducer 60 and transmitted to the output shaft 70. In the present embodiment, the deceleration is sequentially performed via the three-stage planetary gear mechanisms. The swinging operation of the upper swing body 230 is performed by the rotation of the output shaft 70.

The electric motor 20 is driven with high torque when the upper swing body 230 swings. Accordingly, the temperatures of the rotor core 42 and the permanent magnet rise due to the iron loss in the rotor core 42 and the eddy current loss in the permanent magnet. At the same time, the temperature of the stator 30 rises due to the copper loss in the coil 32 and the iron loss in the stator core 31. When the temperature of the stator 30 is high, the temperature of the rotor core 42 becomes higher due to the radiant heat of the stator 30. Accordingly, cooling oil is supplied into the electric motor 20 by the lubricating oil circulation unit 150.

When the swinging lever is operated, the lubricating oil pump 152 of the lubricating oil circulation unit 150 is driven together with the drive of the electric motor 20. As a result, the lubricating oil stored by the lower accommodation space R2 being used as a tank is partially introduced into the intra-rotor flow path F of the electric motor 20 via the lubricating oil flow path 151. The lubricating oil cools the rotor core 42 and the permanent magnets in the course of flowing through the intra-rotor flow path F. Then, the lubricating oil discharged from the rotor 38 to the upper accommodation space R1 in the electric motor casing 21 is sprayed radially outward by the centrifugal force resulting from the rotation of the rotor 38 and cools the coil 32 and the stator core 31.

Subsequently, the lubricating oil that has fallen in the upper accommodation space R1 passes through the communication hole 50 penetrating the lower bottom portion 27 of the electric motor casing 21 or passes through the lower bearing 37. Then, the lubricating oil is introduced into the lower accommodation space R2 in the speed reducer casing 61. The lubricating oil passes through the lower bearing 37 and thus lubricity is ensured in the lower bearing 37.

The lubricating oil introduced into the lower accommodation space R2 merges with the lubricating oil stored by the lower accommodation space R2 being used as a tank. In the lower accommodation space R2, each planetary gear mechanism is lubricated by the lubricating oil falling from the electric motor casing 21 or by the stored lubricating oil.

Here, in the present embodiment, the first stage planetary gear mechanism 90, which is one of the plurality of planetary gear mechanisms in the transmission unit 80, is not immersed in the lubricating oil stored in the lower accommodation space R2. In addition, the brake mechanism 120 is not immersed in the lubricating oil. The first stage planetary gear 92 of the first stage planetary gear mechanism 90 and the brake disk 122 of the brake mechanism 120 rotate at a speed higher than the rotation speeds of the planetary gears of the other planetary gear mechanisms. Accordingly, since the first stage planetary gear 92 and the brake disk 122 are not immersed in the lubricating oil, the stirring loss of the lubricating oil as the entire transmission unit 80 can be reduced.

It is necessary to ensure the lubricity of the first stage planetary gear 92 and the brake disk 122 that are not immersed in the lubricating oil as described above. In the present embodiment, lubricating oil is supplied to the sliding surface S1 between the first stage planetary gear 92 and the first stage carrier 93 and the sliding contact surface S2 between the brake disk 122 and the brake plate 123 via the annular member 170.

In other words, as shown in FIGS. 5 and 6, the lubricating oil introduced into the lower accommodation space R2 via the inner peripheral-side communication hole 51 and the outer peripheral-side communication hole 52, which are the communication holes 50 of the electric motor casing 21, partially reaches the inner peripheral side of the annular member 170. The lubricating oil is accommodated in each of the upper oil sump 175 and the lower oil sump 176 in the inner peripheral surface of the annular member 170 in accordance with the centrifugal force.

The lubricating oil accommodated in the upper oil sump 175 flows through the upper lubricating oil supply hole 180 in accordance with the centrifugal force and is discharged from the disk support surface 172a. As a result, the lubricating oil is supplied to the sliding contact surface S2 between the brake disk 122 and the brake plate 123 and lubricity is ensured on the sliding contact surface S2. The lubricating oil guided to the brake disk 122 and the brake plate 123 passes through the through hole 123a of the brake plate 123 and flows downward. Then, the lubricating oil passes through the guiding recessed portion 65a of the overhanging portion 65 and further flows downward from the radially inner end portion of the guiding recessed portion 65a.

The lubricating oil accommodated in the lower oil sump 176 flows through the lower lubricating oil supply hole 181 in accordance with the centrifugal force and is introduced into the intra-shaft flow path 162 of the carrier shaft 161 from the first opening portion 162a. The lubricating oil that has flowed through the intra-shaft flow path 162 is discharged from the second opening portion 162b of the intra-shaft flow path 162 and is supplied to the sliding surface S1 between the carrier shaft 161 and the first stage planetary gear 92. As a result, the lubricity of the sliding surface SI is ensured.

As described above, in the present embodiment, the lubricating oil that has reached the inner peripheral surface of the annular member 170 by being supplied into the speed reducer casing 61 from above is temporarily collected in the oil sump and then flows through the lubricating oil supply hole toward the outer peripheral side in accordance with the centrifugal force. Then, the lubricating oil discharged from the lubricating oil supply hole is supplied to the sliding portion on the radially outer side of the lubricating oil supply hole. As a result, lubricity can be ensured for the sliding portion.

In addition, the lower oil sump 176 positioned below is positioned radially inward of the upper oil sump 175 positioned above. Accordingly, the lubricating oil that the upper oil sump 175 has failed to accommodate drips down from the upper oil sump 175 and is introduced into the lower oil sump 176. As a result, it is possible to smoothly supply the lubricating oil to both the upper oil sump 175 and the lower oil sump 176.

Further, the upper oil sump 175 and the lower oil sump 176 have the receiving surfaces 175b and 176b, respectively. Since there are no other structures other than the annular member 170 above the receiving surfaces 175b and 176b, the lubricating oil falling from the communication hole 50 of the electric motor casing 21 can be received by the receiving surfaces 175b and 176b. The lubricating oil received by the receiving surfaces 175b and 176b is accommodated in the recessed grooves 175a and 176a in accordance with the centrifugal force of the rotating annular member 170. In addition, the lubricating oil that has received the centrifugal force is capable of remaining on the receiving surfaces 175b and 176b. In other words, it is possible for the receiving surfaces 175b and 176b themselves to be functioned as lubricating oil storage portions. As a result, the upper oil sump 175 and the lower oil sump 176 are capable of accommodating more lubricating oil than in a case where only the receiving surfaces 175b and 176b are formed.

In addition, in the present embodiment, a configuration in which lubricating oil is supplied from the upper oil sump 175 and the lower oil sump 176 is adopted, and thus it is possible to reliably lubricate the sliding portions of the first stage planetary gear mechanism 90 and the brake mechanism 120.

In particular, even in a case where the hydraulic shovel 200 is on a slope, it is possible to more reliably lubricate the first stage planetary gear mechanism 90 and the brake mechanism 120 by guiding lubricating oil radially outward from the upper oil sump 175 and the lower oil sump 176 by means of the centrifugal force.

Here, the brake mechanism 120 needs to ensure more lubricity than the first stage planetary gear mechanism 90. In other words, the brake disk 122 and the brake plate 123 may be in contact with each other at all times, and thus it is preferable that a large amount of lubricating oil is supplied to the sliding contact surface S2 between the brake disk 122 and the brake plate 123. In this regard, in the present embodiment, the volume by which lubricating oil can be accommodated in the upper oil sump 175 is larger than the volume by which lubricating oil can be accommodated in the lower oil sump 176. As a result, lubricity can be sufficiently ensured for the brake disk 122 to which lubricating oil is guided via the upper oil sump 175. It is possible to supply an appropriate amount of lubricating oil to the first stage planetary gear mechanism 90 via the lower oil sump 176.

Here, the fitting portion between the lower end of the rotary shaft 40 and the first stage transmission shaft 91 rotates at a high speed. Accordingly, fretting wear may occur in the fitting portion.

In the present embodiment, the gutter portion 136 is provided integrally with the brake piston 130. The lubricating oil introduced into the lower accommodation space R2 via the communication hole 50 of the electric motor casing 21 partially reaches the gutter portion 136, flows through the flow path groove 136a, and falls from above the fitting portion. Lubricity is ensured for the fitting portion by the lubricating oil being supplied to the fitting portion. The fretting wear can be suppressed as a result.

### Another Embodiment

Although the embodiment of the present invention has been described above, the present invention is not limited thereto and can be appropriately changed without departing from the technical idea of the present invention.

Described in the embodiment is an example in which the annular member 170 is provided integrally with the first stage carrier 93 of the first stage planetary gear mechanism 90. However, the present invention is not limited thereto. For example, the annular member 170 may be provided integrally with another component of the transmission unit 80 or may be provided integrally with the rotary shaft 40.

Although an example in which both the upper oil sump 175 and the lower oil sump 176 are formed in the annular member 170 has been described in the embodiment, only one of the upper oil sump 175 and the lower oil sump 176 may be formed. Correspondingly, only one of the upper lubricating oil supply hole 180 and the lower lubricating oil supply hole 181 may be formed.

The brake mechanism 120 is not limited to the example of being disposed above the first stage planetary gear mechanism 90. For example, the brake mechanism 120 may be disposed at another location, examples of which include the location between the first stage planetary gear mechanism 90 and the second stage planetary gear mechanism 100 and the location between the second stage planetary gear mechanism 100 and the third stage planetary gear mechanism 110.

The planetary gear mechanisms are not limited to three stages and may be replaced with a single-stage planetary gear mechanism or those with a plurality of stages such as two stages and four or more stages. In addition, the brake mechanism 120 may be disposed at any position with respect to the planetary gear mechanisms.

Another sliding portion may be adopted although the sliding surface S1 between the first stage planetary gear 92 and the carrier shaft 161 and the sliding contact surface S2 between the brake disk 122 and the brake plate 123 have been described as examples of the sliding portion in the embodiment. In other words, lubricating oil may be supplied to another sliding portion requiring the lubricating oil via the oil sump of the annular member 170 and the lubricating oil supply hole.

Three or more oil sumps may be formed in the annular member with three or more lubricating oil supply holes formed so as to correspond to the oil sumps. In this case, the oil sump disposed lower than another one may be provided radially inward than the other one. In this manner, the lower oil sump also can be appropriately supplied with the lubricating oil that has flowed downward from the upper oil sump.

A plurality of lubricating oil supply holes guiding lubricating oil to different sliding portions may be formed with respect to one oil sump.

Although the rotary drive system 1 of the present embodiment is configured to use the electric motor 20, a hydraulic motor or the like may be applied instead of the electric motor 20 or a configuration in which the electric motor 20 and a hydraulic motor are combined may be applied.

Although an example in which the present invention is applied to the rotary drive system 1 of the hydraulic shovel 200 as a work machine has been described in the embodiment, the present invention may be applied to the rotary drive system 1 as a mechanism swinging or rotating part of another work machine. The present invention may be applied to a speed reducer alone as well as the rotary drive system 1 including the electric motor 20 and the speed reducer 60.

### INDUSTRIAL APPLICABILITY

According to the speed reducer, the rotary drive system, and the hydraulic shovel of the above aspect, it is possible to smoothly supply lubricating oil to a sliding portion.

### REFERENCE SIGNS LIST

1: Rotary drive system

10: Rotary drive device

20: Electric motor

21: Electric motor casing

21a: Lower surface

22: Upper casing

23: Upper cylindrical portion

24: Upper bottom portion

25: Lower casing

26: Lower cylindrical portion

27: Lower bottom portion

27a: Lower through hole

27b: First bottom surface

27c: Second bottom surface

27d: Stepped portion

28: Casing-side accommodation recessed portion

30: Stator

31: Stator core

32: Coil

35: Upper seal

36: Upper bearing

37: Lower bearing

38: Rotor

40: Rotary shaft

42: Rotor core

45: Lower end plate

46: Upper end plate

50: Communication hole

51: Inner peripheral-side communication hole

52: Outer peripheral-side communication hole

60: Speed reducer

61: Speed reducer casing

61a: Hydraulic pressure supply hole

62a: First stage inner gear teeth

62b: Second stage inner gear teeth

62c: Third stage inner gear teeth

64a: First sliding contact inner peripheral surface

64b: Second sliding contact inner peripheral surface

64c: Stepped surface

65: Overhanging portion

65a: Guiding recessed portion

70: Output shaft

71: Output shaft bearing

72: Lower seal

80: Transmission unit

90: First stage planetary gear mechanism

91: First stage transmission shaft (transmission shaft)

91a: Cylindrical portion

91b: Upper end

91c: Flange portion

91d: Sun gear teeth

92: First stage planetary gear (planetary gear)

92a: Planetary gear teeth

93: First stage carrier (carrier)

100: Second stage planetary gear mechanism

101: Second stage transmission shaft

101a: Sun gear teeth

102: Second stage planetary gear

103: Second stage carrier

110: Third stage planetary gear mechanism

111: Third stage transmission shaft

111a: Sun gear teeth

112: Third stage planetary gear

113: Third stage carrier

120: Brake mechanism

122: Brake disk

123: Brake plate

123a: Through hole

130: Brake piston

130a: Upper surface

130b: Lower surface

131: First sliding contact outer peripheral surface

132: Second sliding contact outer peripheral surface

133: Pressure receiving surface

134: Plate abutting surface

135: Piston-side accommodation recessed portion (recessed portion)

136: Gutter portion

136a: Flow path groove

140: Brake spring

150: Lubricating oil circulation unit

151: Lubricating oil flow path

152: Lubricating oil pump

153: Cooling unit

154: Strainer

161: Carrier shaft

162: Intra-shaft flow path

162a: First opening portion

162b: Second opening portion

163: Upper radial flow path

164: Intermediate radial flow path

165: Axial flow path

167: Carrier main body

167a: Lower fitting hole

170: Annular member

171: Annular plate portion

171a: Upper fitting hole (fitting hole)

172: Annular cylindrical portion

172a: Disk support surface

175: Upper oil sump (oil sump)

175a: Recessed groove

175b: Receiving surface

176: Lower oil sump (oil sump)

176a: Recessed groove

176b: Receiving surface

177: Connecting inner peripheral surface

180: Upper lubricating oil supply hole (lubricating oil supply hole)

181: Lower lubricating oil supply hole (lubricating oil supply hole)

200: Hydraulic shovel

211: Crawler

210: Undercarriage

220: Swing circle

221: Outer race

222: Inner race

223: Swing pinion

230: Upper swing body

231: Cab

232: Work equipment

233: Boom

234: Arm

235: Bucket

236: Engine

237: Generator motor

238: Hydraulic pump

239: Inverter

240: Capacitor

L: Swing axis

O: Axis

S: Liquid surface

R1: Upper accommodation space

R2: Lower accommodation space

R3: Spring accommodation space

R4: Hydraulic pressure supply space

F: Intra-rotor flow path

S1: Sliding surface (sliding portion)

S2: Sliding contact surface (sliding portion)

1. A speed reducer comprising:
an output shaft provided below a rotary shaft that has an axis extending vertically and rotates around the axis, and provided to be rotatable around the axis;
a transmission unit interconnecting a lower portion of the rotary shaft and the output shaft, decelerating a rotation of the rotary shaft, and transmitting a decelerated rotation of the rotary shaft to the output shaft;
an annular member having a cylindrical shape surrounding the axis and rotating around the axis together with the transmission unit, the annular member including an oil sump having a recessed groove recessed in an inner peripheral surface of the annular member and a lubricating oil supply hole extending radially outward from the recessed groove and being opened; and
a sliding portion provided on an outer side of the lubricating oil supply hole of the annular member in a radial direction of the axis.

2. The speed reducer according to claim 1, wherein
a plurality of the oil sumps are formed to be vertically spaced from each other,
a plurality of the lubricating oil supply holes are formed so as to correspond to the respective oil sumps, and
the plurality of oil sumps are provided such that the oil sump disposed lower than another one is provided radially inward than the another one.

3. The speed reducer according to claim 1, wherein
the oil sump has a receiving surface extending from a lower end of the recessed groove toward a radially inner side with respect to the axis and facing upward.

4. The speed reducer according to claim 1, further comprising:
a speed reducer casing forming a lower accommodation space accommodating the rotary shaft, the output shaft, the transmission unit, the annular member, and the sliding portion and supplied with lubricating oil from above; and
a brake mechanism including a brake disk overhanging to an outer peripheral side from an outer peripheral surface of the annular member, a brake plate overhanging to an inner peripheral side from an inner peripheral surface of the speed reducer casing, and a brake piston having an annular shape surrounding the axis, disposed so as to be vertically reciprocable above the brake disk and the brake plate, and allowing the brake disk to be pressed via the brake plate, wherein
the lubricating oil supply hole extends from a recessed groove of the oil sump toward the radially outer side and is open in the outer peripheral surface of the annular member, and
the sliding portion is a sliding contact surface between the brake disk and the brake plate.

5. The speed reducer according to claim 1, wherein
the transmission unit includes a first stage planetary gear mechanism,
the first stage planetary gear mechanism includes
a transmission shaft fitted to a lower end of the rotary shaft and having an outer peripheral surface where sun gear teeth are formed;
a planetary gear meshing with the sun gear teeth; and
a carrier having a carrier shaft rotatably supporting the planetary gear and a carrier main body supporting a lower portion of the carrier shaft and rotatable around the axis,
the annular member has a fitting hole externally fitted to an upper portion of the carrier shaft and is rotatable around an axis integrally with the carrier main body,
the carrier shaft has an intra-shaft flow path having a first opening portion opening to the fitting hole and a second opening portion opening to the planetary gear,
the oil sump includes a lower oil sump,
the lubricating oil supply hole has a lower lubricating oil supply hole extending from the recessed groove of the lower oil sump toward the radially outer side, opening to the fitting hole, and communicating with the first opening portion, and
the sliding portion is a sliding surface between the carrier shaft and the planetary gear.

6. The speed reducer according to claim 5, further comprising:
a speed reducer casing forming a lower accommodation space accommodating the rotary shaft, the output shaft, the transmission unit, the annular member, and the sliding portion and supplied with lubricating oil from above; and
a brake mechanism including a brake disk overhanging to an outer peripheral side from an outer peripheral surface of the annular member, a brake plate overhanging to an inner peripheral side from an inner peripheral surface of the speed reducer casing, and a brake piston having an annular shape surrounding the axis, disposed so as to be vertically reciprocable above the brake disk and the brake plate, and being capable of pressing the brake disk via the brake plate, wherein
the oil sump includes an upper oil sump disposed above the lower oil sump,
the lubricating oil supply hole has an upper lubricating oil supply hole extending from a recessed groove of the upper oil sump toward the radially outer side and opening in the outer peripheral surface of the annular member where the brake disk is supported,
the sliding portion is a sliding contact surface between the brake disk and the brake plate, and
the upper oil sump is larger in volume than the lower oil sump.

7. The speed reducer according to claim 6, wherein
the brake piston has a gutter portion forming a flow path groove that extends toward a radially inner side with respect to the axis and opens above a fitting portion between the rotary shaft and the transmission shaft.

8. A hydraulic shovel comprising:
an undercarriage;
an upper swing body provided above the undercarriage; and
a rotary drive system including the speed reducer according to claim 1 and swinging the upper swing body with respect to the undercarriage.

9. A rotary drive system comprising:
the speed reducer according to claim 1 including a speed reducer casing forming a lower accommodation space accommodating the rotary shaft, the output shaft, the transmission unit, the annular member, and the sliding portion and supplied with lubricating oil from above;
an electric motor including
the rotary shaft rotating around the axis,
a rotor core fixed to an upper portion of the rotary shaft,
a stator surrounding the rotor core from an outer peripheral side of the rotor core, and
an electric motor casing forming an upper accommodation space accommodating the rotary shaft, the rotor core, and the stator above and apart from the lower accommodation space and having a communication hole allowing the upper accommodation space and the lower accommodation space to vertically communicate with each other; and
a lubricating oil circulation unit supplying lubricating oil stored in the lower accommodation space into the upper accommodation space.

10. A hydraulic shovel comprising:
an undercarriage;
an upper swing body provided above the undercarriage; and
the rotary drive system according to claim 9 configured to swing the upper swing body with respect to the undercarriage.)

11. The speed reducer according to claim 2, wherein
the oil sump has a receiving surface extending from a lower end of the recessed groove toward a radially inner side with respect to the axis and facing upward.)

12. The speed reducer according to claim 2, further comprising:
a speed reducer casing forming a lower accommodation space accommodating the rotary shaft, the output shaft, the transmission unit, the annular member, and the sliding portion and supplied with lubricating oil from above; and
a brake mechanism including a brake disk overhanging to an outer peripheral side from an outer peripheral surface of the annular member, a brake plate overhanging to an inner peripheral side from an inner peripheral surface of the speed reducer casing, and a brake piston having an annular shape surrounding the axis, disposed so as to be vertically reciprocable above the brake disk and the brake plate, and allowing the brake disk to be pressed via the brake plate, wherein
the lubricating oil supply hole extends from a recessed groove of the oil sump toward the radially outer side and is open in the outer peripheral surface of the annular member, and
the sliding portion is a sliding contact surface between the brake disk and the brake plate.)

13. The speed reducer according to claim 3, further comprising:
a speed reducer casing forming a lower accommodation space accommodating the rotary shaft, the output shaft, the transmission unit, the annular member, and the sliding portion and supplied with lubricating oil from above; and
a brake mechanism including a brake disk overhanging to an outer peripheral side from an outer peripheral surface of the annular member, a brake plate overhanging to an inner peripheral side from an inner peripheral surface of the speed reducer casing, and a brake piston having an annular shape surrounding the axis, disposed so as to be vertically reciprocable above the brake disk and the brake plate, and allowing the brake disk to be pressed via the brake plate, wherein
the lubricating oil supply hole extends from a recessed groove of the oil sump toward the radially outer side and is open in the outer peripheral surface of the annular member, and
the sliding portion is a sliding contact surface between the brake disk and the brake plate.

14. The speed reducer according to claim 2, wherein
the transmission unit includes a first stage planetary gear mechanism,
the first stage planetary gear mechanism includes
a transmission shaft fitted to a lower end of the rotary shaft and having an outer peripheral surface where sun gear teeth are formed;
a planetary gear meshing with the sun gear teeth; and
a carrier having a carrier shaft rotatably supporting the planetary gear and a carrier main body supporting a lower portion of the carrier shaft and rotatable around the axis,
the annular member has a fitting hole externally fitted to an upper portion of the carrier shaft and is rotatable around an axis integrally with the carrier main body,
the carrier shaft has an intra-shaft flow path having a first opening portion opening to the fitting hole and a second opening portion opening to the planetary gear,
the oil sump includes a lower oil sump,
the lubricating oil supply hole has a lower lubricating oil supply hole extending from the recessed groove of the lower oil sump toward the radially outer side, opening to the fitting hole, and communicating with the first opening portion, and
the sliding portion is a sliding surface between the carrier shaft and the planetary gear.

15. The speed reducer according to claim 3, wherein
the transmission unit includes a first stage planetary gear mechanism,
the first stage planetary gear mechanism includes
a transmission shaft fitted to a lower end of the rotary shaft and having an outer peripheral surface where sun gear teeth are formed;
a planetary gear meshing with the sun gear teeth; and
a carrier having a carrier shaft rotatably supporting the planetary gear and a carrier main body supporting a lower portion of the carrier shaft and rotatable around the axis,
the annular member has a fitting hole externally fitted to an upper portion of the carrier shaft and is rotatable around an axis integrally with the carrier main body,
the carrier shaft has an intra-shaft flow path having a first opening portion opening to the fitting hole and a second opening portion opening to the planetary gear,
the oil sump includes a lower oil sump,
the lubricating oil supply hole has a lower lubricating oil supply hole extending from the recessed groove of the lower oil sump toward the radially outer side, opening to the fitting hole, and communicating with the first opening portion, and
the sliding portion is a sliding surface between the carrier shaft and the planetary gear.

16. A hydraulic shovel comprising:
an undercarriage;
an upper swing body provided above the undercarriage; and
a rotary drive system including the speed reducer according to claim 2 and swinging the upper swing body with respect to the undercarriage.

17. A hydraulic shovel comprising:
an undercarriage;
an upper swing body provided above the undercarriage; and
a rotary drive system including the speed reducer according to claim 3 and swinging the upper swing body with respect to the undercarriage.

18. A hydraulic shovel comprising:
an undercarriage;
an upper swing body provided above the undercarriage; and
a rotary drive system including the speed reducer according to claim 4 and swinging the upper swing body with respect to the undercarriage.

19. A rotary drive system comprising:
the speed reducer according to claim 2 including a speed reducer casing forming a lower accommodation space accommodating the rotary shaft, the output shaft, the transmission unit, the annular member, and the sliding portion and supplied with lubricating oil from above;
an electric motor including
the rotary shaft rotating around the axis,
a rotor core fixed to an upper portion of the rotary shaft,
a stator surrounding the rotor core from an outer peripheral side of the rotor core, and
an electric motor casing forming an upper accommodation space accommodating the rotary shaft, the rotor core, and the stator above and apart from the lower accommodation space and having a communication hole allowing the upper accommodation space and the lower accommodation space to vertically communicate with each other; and
a lubricating oil circulation unit supplying lubricating oil stored in the lower accommodation space into the upper accommodation space.

20. A rotary drive system comprising:
the speed reducer according to claim 3 including a speed reducer casing forming a lower accommodation space accommodating the rotary shaft, the output shaft, the transmission unit, the annular member, and the sliding portion and supplied with lubricating oil from above;
an electric motor including
the rotary shaft rotating around the axis,
a rotor core fixed to an upper portion of the rotary shaft,
a stator surrounding the rotor core from an outer peripheral side of the rotor core, and
an electric motor casing forming an upper accommodation space accommodating the rotary shaft, the rotor core, and the stator above and apart from the lower accommodation space and having a communication hole allowing the upper accommodation space and the lower accommodation space to vertically communicate with each other; and
a lubricating oil circulation unit supplying lubricating oil stored in the lower accommodation space into the upper accommodation space.
